(19) United States
(12) Patent Application Publication
(10) Pub. No.: US 2012/0213570 A1
(43) Pub. Date: Aug. 23, 2012

(54) VERTICAL PRINTER CONFIGURATION FOR TANDEM PRINTING

(76) Inventor: Harry R. Lewis, Longmont, CO (US)

(21) Appl. No.: 13/030,247

(22) Filed: Feb. 18, 2011

(51) Int. Cl. B41J 15/02

(52) U.S. Cl. 400/614

(57) ABSTRACT

Systems are disclosed that provide a vertical configuration for tandem printing. A printer rack allows for one printer to be stacked above another printer in a vertical configuration. When the printers are installed on the printer rack, the printers face in opposite directions so that an output of one of the printers is vertically aligned with an input of the other printer. A paper web may then be fed through one printer for front side printing, and then through the other printer for back side printing. The printer rack includes a web reversing mechanism that reverses a direction of travel of the paper web as the paper web is fed between the printers and eliminates the need for a traditional turning station as commonly used in horizontal tandem printing system configurations.

### FIELD OF THE INVENTION

The invention relates to the field of production printing and, in particular, to printers that are stacked in a vertical configuration for tandem printing.

### BACKGROUND

Businesses or other entities having a need for volume printing typically install continuous-forms printers that print on a paper web. The paper web is initially in a roll, and is loaded on an unwinder mechanism. The paper web is fed from the unwinder mechanism to a first printer where the first printer prints on a front side of the paper web. The paper web is then fed from the first printer to a turning or flipping station that flips the paper web so that the opposite (back) side of the web faces the drum or print head. After being flipped, the paper web is fed to a second printer, which prints on the back side of the paper web. The paper web is then fed from the second printer to a winder mechanism that again winds the paper web into a roll. The paper web may alternatively be fed from the second printer to one or more post-printing stations, such as for cutting the paper web into individual sheets.

When both sides of a paper web are printed as described above, this is referred to as tandem printing or double-sided printing. For tandem printing, there are a variety of ways that the printers may be configured. One type of tandem configuration is an inline configuration, where the first printer and the second printer are in line with one another on a production floor. Another type of tandem configuration is an L-shaped configuration, where the first printer is positioned perpendicular to the second printer on a production floor. Yet another type of tandem configuration is a U-shaped configuration, where the first printer and the second printer are positioned side-by-side and parallel to one another on a production floor. In each of these configurations, a turning station is required on the production floor between the first printer and the second printer that flips the paper web as it is fed from the first printer to the second printer.

The footprints of tandem configurations tend to take up a large area of the production floor. Because floor space can be an issue, it is desirable to reduce the footprint size and the various tandem configurations discussed above have evolved in attempt to optimize use of the production floor space.

### SUMMARY

Embodiments described herein provide for a vertical configuration for tandem printing. A printer rack described herein allows for one printer to be stacked above a second printer in a vertical configuration. When the printers are installed on the printer rack, the printers face in opposite directions so that an output of one printer is vertically aligned with an input of the other printer. A paper web may then be fed through the first printer for front side printing, and then through the second printer for back side printing. The printer rack includes a web reversing mechanism that reverses a direction of travel of the paper web as the paper web is fed between the first printer and the second printer. For example, as the paper web exits the first printer, one or more rollers in the web reversing mechanism cause the paper web to make a U-turn before the paper web enters the second printer. When the direction of travel of the paper web is reversed in this manner between printers that are stacked in a vertical configuration (and facing in opposite directions), the first and second printers are able to print on opposite sides of the paper web (e.g., front side and back side). This is advantageous in that a vertical configuration has a smaller footprint than other tandem configurations. Also, there is no need to install a traditional turning station between the first printer and the second printer to flip the paper web for double-sided printing as in other tandem configurations, because the vertical configuration of the printers inherently allows one printer to print on the front side and the other printer to print on the back side of the paper web. This is advantageous because turning stations can be prone to cause errors or paper jams.

In one embodiment, the printer rack includes a support structure having a plurality of vertical leg members, and having a horizontal base member affixed to the leg members at an elevated height in order to support a first printer above a second printer. The base member is affixed to the leg members at the elevated height so that a volume beneath the base member is at least as large as a volume of the second printer.

In another embodiment, the web reversing mechanism includes a first web guide and a second web guide. The first web guide is aligned with an output of the first printer, and is configured to receive the paper web from the output of the first printer, and to alter the direction of travel of the paper web from a first horizontal direction to a vertical direction. The second web guide is aligned with an input of the second printer, and is configured to receive the paper web from the first web guide, to alter the direction of travel of the paper web from the vertical direction to a second horizontal direction that is opposite the first horizontal direction of the paper web exiting the first printer, and to guide the paper web into the input of the second printer. These web guides act to reverse the direction of travel of the paper web as the web is fed from the first printer to the second printer.

The invention may include other exemplary embodiments described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a vertical printer rack for tandem printing in an exemplary embodiment.

FIG. 2 illustrates a web reversing mechanism for a vertical printer rack in an exemplary embodiment.

FIG. 3 illustrates a vertical printer rack with tandem printers installed in an exemplary embodiment.

FIG. 4 illustrates a vertical printer rack with tandem printers installed in another exemplary embodiment.

FIG. 5 illustrates a vertical printer rack for tandem printing in another exemplary embodiment.

FIG. 6 illustrates a vertical printer rack for tandem printing in another exemplary embodiment.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

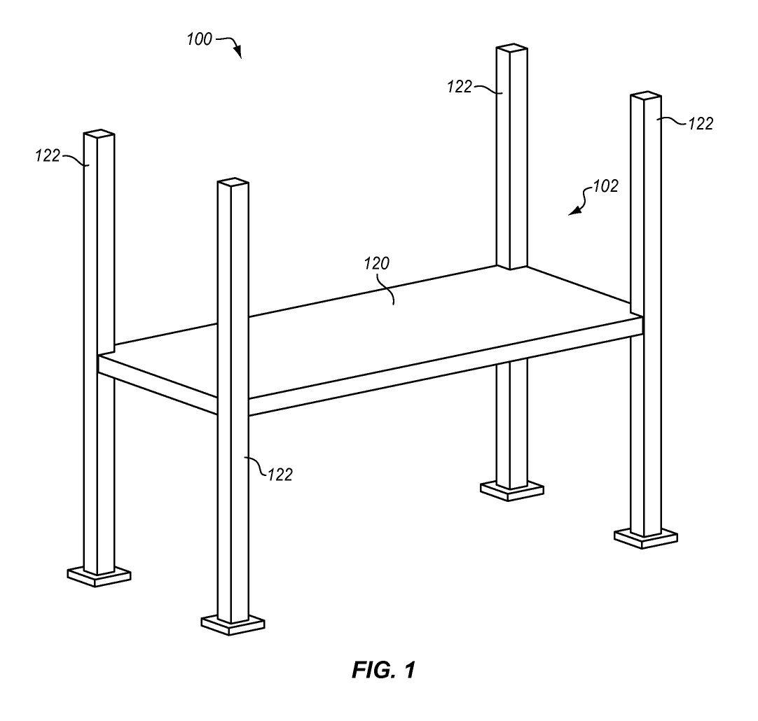

FIG. 1 illustrates a vertical printer rack 100 for tandem printing in an exemplary embodiment. Vertical printer rack 100 is configured to stack one continuous-forms printer on top of another continuous-forms printer to allow for tandem printing between those two printers. When stacked, one of the continuous-forms printers prints on a front side of a paper web, while the other of the continuous-forms printers prints on a back side of the paper web. This is referred to as tandem printing.

Vertical printer rack 100 includes a support structure 102. Support structure 102 includes a horizontal base member 120 and a plurality of vertical leg members 122. Base member 120 has a shape such that an area of the top surface of base member 120 is at least as large as the base of a continuous-forms printer, such as an InfoPrint® 5000. Base member 120 may comprise a sheet of material (e.g., solid or mesh) upon which a printer may be set or affixed. Base member 120 is connected or affixed to leg members 122 so that it is raised or elevated in relation to a production floor. The height of base member 120 is set in relation to the floor so that a volume underneath base member 120 and above the floor is at least as large as the volume of a continuous-forms printer, again such as an InfoPrint® 5000. Based on this configuration, vertical printer rack 100 is able to store one printer on top of base member 120, and another printer underneath base member 120. The number of leg members 122 used in support structure 102 is a matter of design choice, and may depend on the size of base member 120, the weight of the printers, etc. Also, the structure of vertical printer rack 100 shown in FIG. 1 is just one embodiment, and rack 100 may be constructed in any desired manner so that it is structurally strong enough to support the weight of a continuous-forms printer above base member 120, but yet has sufficient volume underneath base member 120 for another continuous-forms printer.

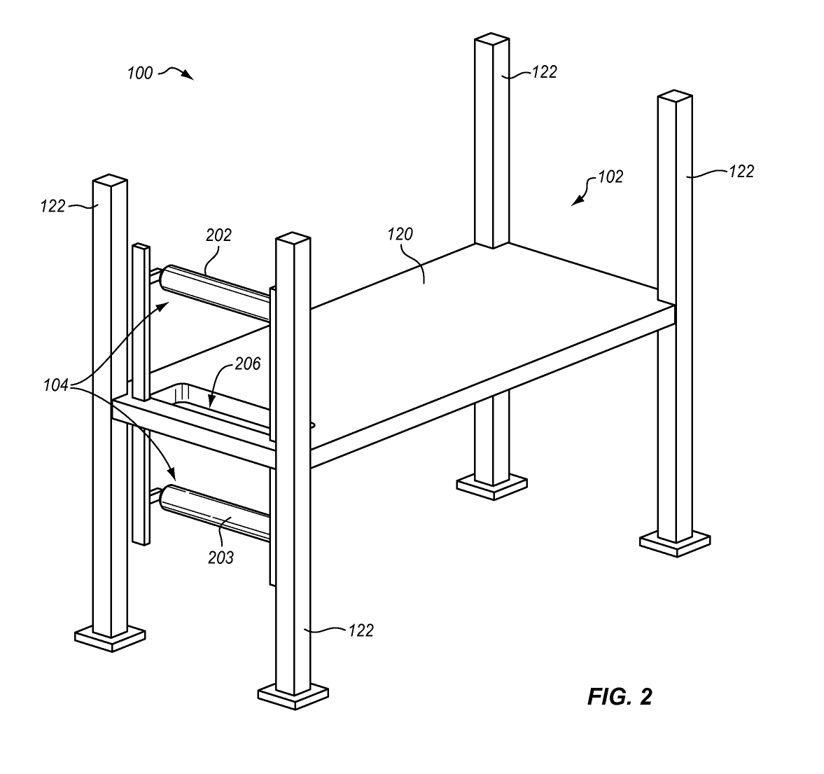

Vertical printer rack 100 further includes a web reversing mechanism 104, one example of which is shown in FIG. 2. Web reversing mechanism 104 is adapted to change/alter a direction of travel of a paper web from one direction to the opposite direction when the paper web is fed between continuous-forms printers that are vertically stacked in vertical printer rack 100. In this embodiment, web reversing mechanism 104 includes a first web guide 202 and a second web guide 203. Web guides 202-203 may be rollers that are fixed, adjustable, or under tension (e.g., spring loaded) so as to guide a paper web between printers when installed on vertical printer rack 100. In the embodiment of vertical printer rack 100 shown in FIG. 2, base member 120 may also include a void 206 or cut-out through which a paper web may travel between web guides 202-203.

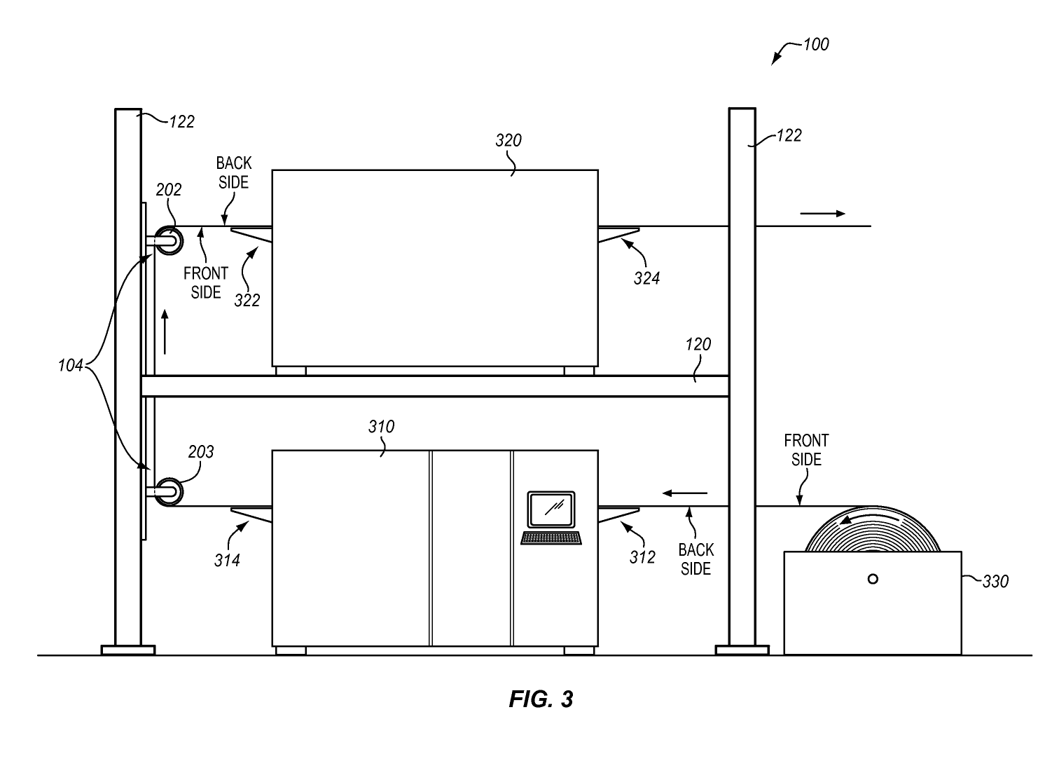

FIG. 3 illustrates vertical printer rack 100 with tandem printers installed in an exemplary embodiment. Assume for this embodiment that printers 310 and 320 are installed for tandem printing so that printer 310 prints to a front side of a paper web, and printer 320 prints to a back side of the paper web. The tandem configuration shown in FIG. 3 is a vertical configuration (also referred to as a vertically-stacked configuration), where printer 320 is positioned directly above printer 310. When printer 320 is stacked on top of printer 310 within vertical printer rack 100, the footprint of the tandem configuration is smaller than footprints of other configurations, such as in-line, L-shaped, U-shaped, etc.

As installed in FIG. 3, printer 310 in installed underneath base member 120 of vertical printer rack 100. As is evident in FIG. 3, a volume underneath base member 120 is at least as large as the volume of printer 310. An input 312 of printer 310 faces to the right side of FIG. 3 and an output 314 of printer 310 faces to the left side of FIG. 3. Printer 320 is installed on the top surface of base member 120. As installed in FIG. 3, an input 322 of printer 320 faces to the left side of FIG. 3 and an output 324 of printer 320 faces to the right side of FIG. 3.

Printer 310 and 320 are facing opposite directions in FIG. 3 so that the front of printer 310 is facing out of the page in FIG. 3 while the front side of printer 320 is facing into the page. The purpose of this is to have the output 314 of printer 310 be on the same side of vertical printer rack 100 as the input 322 of printer 320 so that they are vertically aligned. A paper web may then be fed from the output 314 of printer 310 to the input 322 of printer 320 with the assistance of web reversing mechanism 104. The flow of the paper web is as follows. The paper web is fed from an unwinder mechanism 330 to the input 312 of printer 310. Although not shown in FIG. 3, there may be one or more web guides affixed to support structure 102 to guide the paper web from unwinder mechanism 330 to input 312 of printer 310. The paper web passes through printer 310 in the direction of the arrows, where printer 310 prints on a front side of the paper web. The paper web then travels from output 314 of printer 310 to roller 203 of web reversing mechanism 104. Roller 203 receives the paper web from the output 314, and alters the direction of travel of the paper web from horizontal to vertical, which is upward in FIG. 3. Roller 202 receives the paper web from roller 203 and alters the direction of travel of the paper web from vertical back to horizontal as it is fed to printer 320. However, the horizontal direction of travel of the paper web as it is fed to printer 320 is opposite the direction of travel of the paper web as it exits printer 310. Roller 202 guides the paper web into input 322 of printer 320 where the paper web passes through printer 322 in the direction of the arrows as printer 320 prints on a back side of the paper web (where the “back side” is actually facing upward when it enters printer 320). The paper web then travels from the output 324 of printer 320 to a winder mechanism, to post-printing devices, or any desired mechanism (not shown). Although not shown in FIG. 3, there may be one or more web guides affixed to support structure 102 to guide the paper web from output 324 of printer 320 to an unwinder mechanism, post-printing devices, etc.

The vertically-stacked configuration in FIG. 3 provides advantages over prior horizontally-configured tandem configurations. First, because printers 310 and 320 are stacked above one another, the footprint of the vertically-stacked configuration is reduced. Secondly, with printer 320 stacked on top of printer 310 (and facing in an opposite direction), printers 310 and 320 can print on opposite sides of the paper web (e.g., front side and back side) simply by reversing the direction of travel of the paper web as it is fed between printers 310-320. In an in-line configuration for example, a turning station is needed between a first printer and a second printer to actually flip the paper web. This allows the first printer to print on the front side of the paper web, after which the paper web is flipped and the second printer prints to the back side of the paper web. In any previous tandem configuration, a turning station is needed to print to both sides of a paper web. Unfortunately, the angular direction change that takes place in a turning station can present a disruption to the otherwise linear paper path which can be prone to errors and are often the cause of paper jams.

When printers 310 and 320 are vertically-stacked as in FIG. 3, a traditional turning station is not needed between printers 310 and 320. All that is needed between printers 310 and 320 is a relatively simple web reversing mechanism 104. Web reversing mechanism 104 reverses the direction of travel of the paper web as it travels from printer 310 to printer 320. When printers 310 and 320 are vertically-stacked as in FIG. 3, reversing the direction of travel of the paper web results in the back side of the paper web facing upward when it enters printer 320. Looking at FIG. 3, the paper web enters printer 310 with the front side facing upward and the back side facing downward. After the paper web travels through rollers 202-203, the back side of paper web faces upward and the front side of the paper web faces downward. The paper web is essentially “flipped” between printer 310 and printer 320 due to the over-under configuration of printers 310 and 320, without using a traditional turning station. This is advantageous because web reversing mechanism 104 is less prone to errors or paper jams than is a traditional turning station.

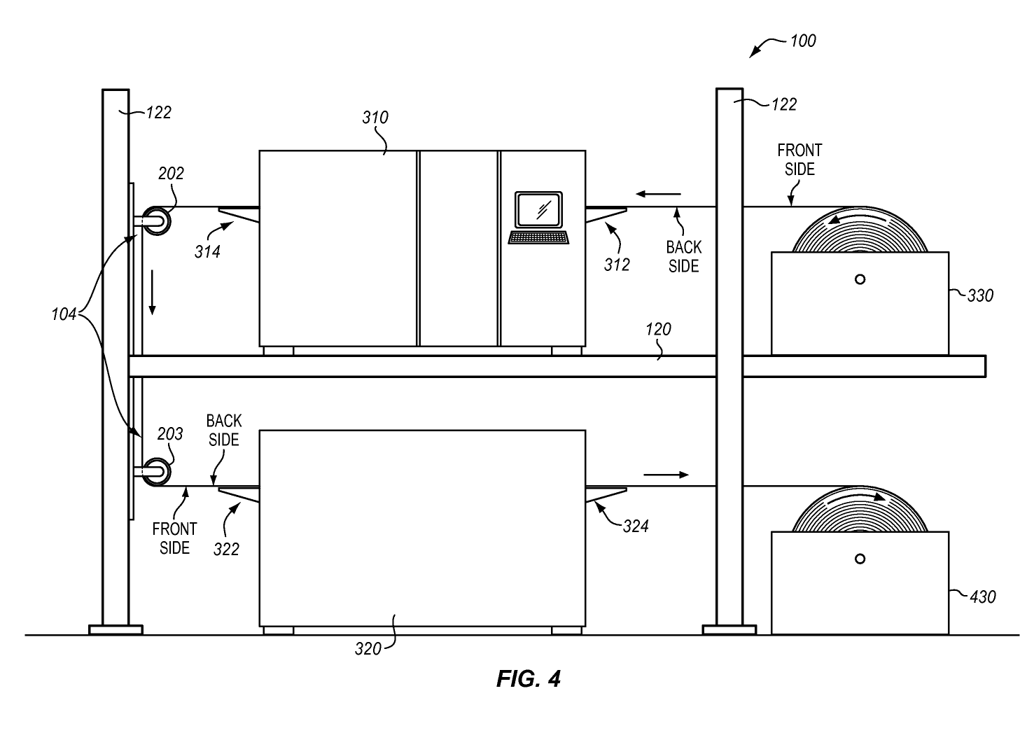

FIG. 4 illustrates vertical printer rack 100 with tandem printers installed in another exemplary embodiment. FIG. 4 is similar to FIG. 3 except that printer 310 is installed on base member 120 of vertical printer rack 100 so that printer 310 is stacked on top of printer 320. In this configuration, the paper web is fed from an unwinder mechanism 330 to the input 312 of printer 310. Unwinder mechanism 330 is shown as being installed on vertical printer rack 100. Thus, vertical printer rack 100 includes an extension member 402 in this embodiment that is adapted to support unwinder mechanism 330 in alignment with printer 310. A similar extension member may be used to support a winder mechanism in alignment with printer 320 in FIG. 3. Also, one or both of a winder mechanism and an unwinder mechanism may be installed on the production floor.

The paper web passes from unwinder mechanism 330 through printer 310 in the direction of the arrows, where printer 310 prints on a front side of the paper web. The paper web then travels from output 314 of printer 310 to roller 202 of web reversing mechanism 104. Roller 202 receives the paper web from the output 314, and alters the direction of travel of the paper web from horizontal to vertical, which is downward in FIG. 4. Roller 203 receives the paper web from roller 202, and alters the direction of travel of the paper web from vertical back to horizontal. However, the horizontal direction of travel of the paper web as it is fed to printer 320 is opposite the direction of travel of the paper web as it exits printer 310. Roller 203 guides the paper web into input 322 of printer 320 where the paper web passes through printer 322 in the direction of the arrows as printer 320 prints on a back side of the paper web (where the “back side” is actually facing upward when it enters printer 320). The paper web then travels from the output 324 of printer 320 to a winder mechanism 430 that again winds the paper web into a roll.

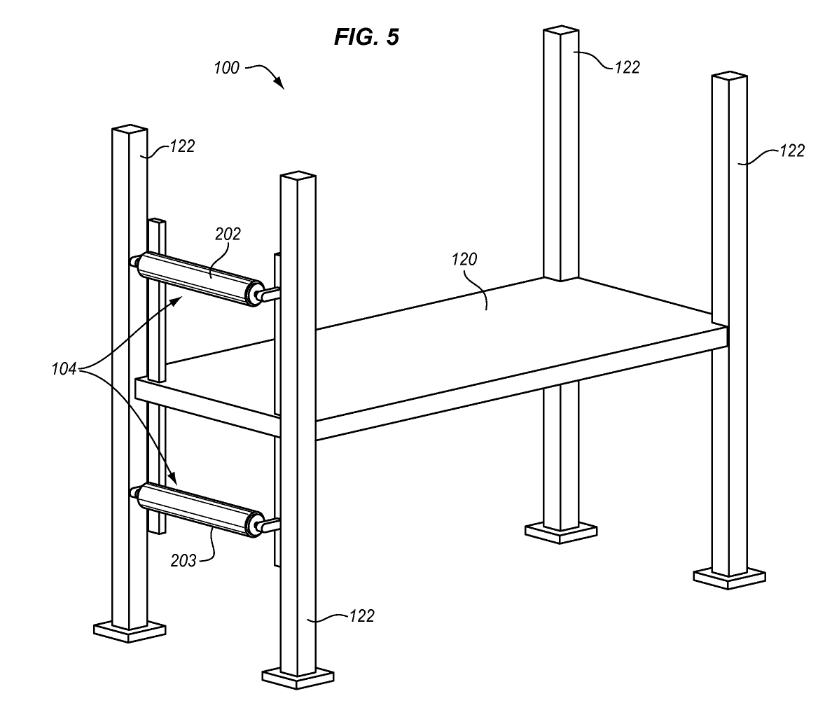

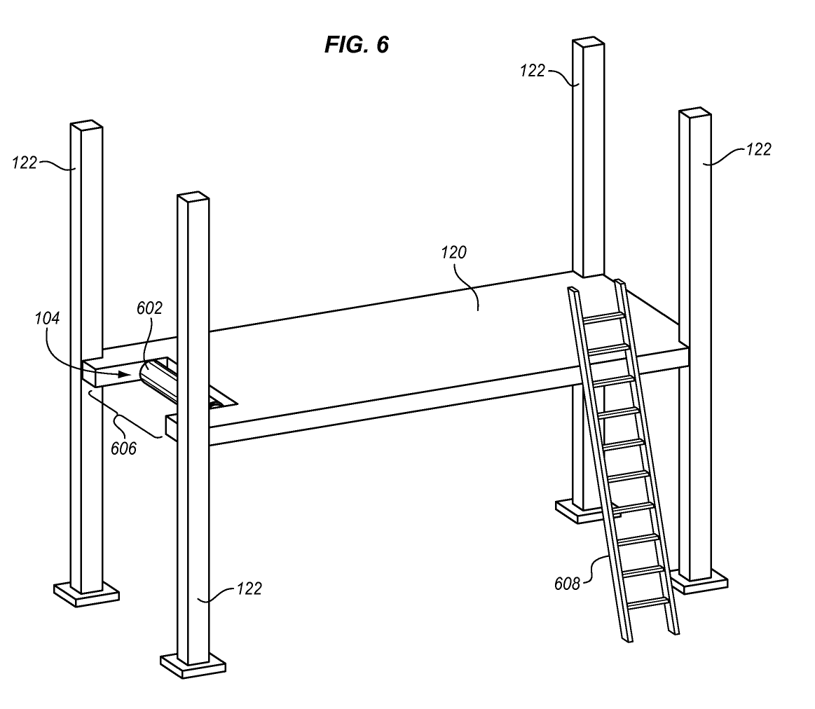

The actual structure used for vertical printer rack 100 may vary depending on desired implementations, one example of which is shown in FIG. 2. FIGS. 5-6 show alternative embodiments for vertical printer rack 100. In the embodiment of FIG. 5, vertical printer rack 100 includes support structure 102 and web reversing mechanism 104. However, in this embodiment, web guides 202-203 of web reversing mechanism 104 face outward from support structure 102. When a paper web travels between web guides 202 and 203, the paper web travels outside of support structure 102 so that there is no need for a void in base member 120 (see FIG. 2 where base member 120 includes void 206).

In the embodiment of FIG. 6, vertical printer rack 100 again includes support structure 102 and web reversing mechanism 104. However, in this embodiment, web reversing mechanism 104 includes a single web guide 602 that is affixed proximate to a void 606 in base member 120. Vertical printer rack 100 also includes a ladder 608 that is movably or fixedly affixed to base member 120. Ladder 608 allows an operator to access a printer that is installed on base member 120 for maintenance, service, etc.

Although specific embodiments were described herein, the scope of the invention is not limited to those specific embodiments. The scope of the invention is defined by the following claims and any equivalents thereof.

I claim:

1. A system comprising:
a support structure configured to support a first printer vertically in relation to a second printer when used for tandem printing; and
a web reversing mechanism configured to reverse a direction of travel of a paper web as the paper web travels between the first printer and the second printer.

2. The system of claim 1 wherein the support structure comprises:
a plurality of vertical leg members; and
a horizontal base member affixed to the leg members at an elevated height to support the first printer above the second printer.

3. The system of claim 2 wherein:
the base member is affixed to the leg members at the elevated height so that a volume beneath the base member is at least as large as a volume of the second printer.

4. The system of claim 2 wherein:
an area of a top surface of the base member is at least as large as a base of the first printer.

5. The system of claim 2 further comprising:
a ladder affixed to the base member to allow an operator to access the first printer.

6. The system of claim 1 wherein the web reversing mechanism comprises:
a first web guide aligned with an output of the first printer, and configured to receive the paper web from the output of the first printer, and to alter the direction of travel of the paper web from a first horizontal direction to a vertical direction; and
a second web guide aligned with an input of the second printer, and configured to receive the paper web from the first web guide, to alter the direction of travel of the paper web from the vertical direction to a second horizontal direction that is opposite the first horizontal direction of the paper web exiting the first printer, and to guide the paper web into the input of the second printer.

7. The system of claim 6 wherein:
the first and second web guides comprise rollers that are under tension.

8. The system of claim 1 wherein the support structure further includes:
an extension member configured to support an unwinder mechanism in alignment with the first printer.

9. A system comprising:
a first printer stacked above a second printer for tandem printing in a vertical configuration; and
a web reversing mechanism configured to reverse a direction of travel of a paper web as the paper web travels between the first printer and the second printer in the vertical configuration.

10. The system of claim 9 wherein:
the first printer and the second printer are stacked on a printer rack, wherein the printer rack comprises:
the web reversing mechanism; and
a support structure having a plurality of vertical leg members, and a horizontal base member affixed to the leg members at an elevated height so that a volume beneath the base member is at least as large as a volume of the second printer;
the base member is configured to support the first printer so that the first printer is stacked above the second printer in the vertical configuration.

11. The system of claim 10 wherein:
an area of a top surface of the base member is at least as large as a base of the first printer.

12. The system of claim 10 further comprising:
a ladder affixed to the base member.

13. The system of claim 10 wherein the support structure further includes:
an extension member configured to support an unwinder mechanism in alignment with the first printer.

14. The system of claim 9 wherein the web reversing mechanism comprises:
a first web guide aligned with an output of the first printer, and configured to receive the paper web from the output of the first printer, and to alter the direction of travel of the paper web from a first horizontal direction to a vertical direction; and
a second web guide aligned with an input of the second printer, and configured to receive the paper web from the first web guide, to alter the direction of travel of the paper web from the vertical direction to a second horizontal direction that is opposite the first horizontal direction of the paper web exiting the first printer, and to guide the paper web into the input of the second printer.

15. A vertical printer rack configured for installation of continuous-forms printers used in tandem printing, the vertical printer rack comprising:
a support structure configured to stack first and second continuous-forms printers in a vertical configuration, the support structure comprising:
a plurality of vertical leg members; and
a horizontal base member affixed to the leg members and configured to support the first continuous-forms printer;
wherein the base member is affixed to the leg members at an elevated height so that a volume beneath the base member is at least as large as a volume of the second continuous-forms printer; and
a web reversing mechanism configured to reverse a direction of travel of a paper web as the paper web travels between the first continuous-forms printer and the second continuous-forms printer such that a front side of the paper web faces upward when fed through one of the first and second continuous-forms printers and the front side of the paper web faces downward when fed through the other of the first and second continuous-forms printers.

16. The vertical printer rack of claim 15 wherein:
an area of a top surface of the base member is at least as large as a base of the first continuous-forms printer.

17. The vertical printer rack of claim 15 further comprising:
a ladder affixed to the base member to allow an operator to access the first continuous-forms printer.

18. The vertical printer rack of claim 15 wherein the web reversing mechanism comprises:
a first web guide aligned with an output of the first continuous-forms printer, and configured to receive the paper web from the output of the first continuous-forms printer, and to alter the direction of travel of the paper web from a first horizontal direction to a vertical direction; and
a second web guide aligned with an input of the second continuous-forms printer, and configured to receive the paper web from the first web guide, to alter the direction of travel of the paper web from the vertical direction to a second horizontal direction that is opposite the first horizontal direction of the paper web exiting the first continuous-forms printer, and to guide the paper web into the input of the second continuous-forms printer.

19. The vertical printer rack of claim 18 wherein:
the first and second web guides comprise rollers that are under tension.

20. The vertical printer rack of claim 15 wherein the support structure further includes:
an extension member configured to support an unwinder mechanism in alignment with the first continuous-forms printer.
